(19) United States
(12) Patent Application Publication
(10) Pub. No.: US 2026/0197351 A1
(43) Pub. Date: Jul. 9, 2026

(54) Mission-Aware Moderation Engine for Ethical and Trust-Aligned Governance

(71) Applicant: George William Bickerstaff, III, Greenwich, CT (US)

(72) Inventor: George William Bickerstaff, III, Greenwich, CT (US)

(21) Appl. No.: 19/309,673

(22) Filed: Aug. 26, 2025

(51) Int. Cl. H04L 9/40

(52) U.S. Cl. CPC H04L 63/20

(57) ABSTRACT

The Mission-Aware Moderation Engine governs digital content by ingesting multi-source data, aligning moderation with organizational missions, applying ethics-based decision models, auditing actions for compliance, and delivering governance outputs via secure interfaces. The system includes a content ingestion module for data intake and validation, a mission alignment processor for contextual scoring, an ethics model for principled moderation, an audit trail generator for traceable records, and a governance interface for secure policy delivery. The method ingests content, aligns with missions, applies ethics, audits results, and outputs governance for applications like social media moderation and decentralized platforms. This invention addresses fragmented moderation by embedding mission-driven and ethical frameworks, ensuring GDPR compliance, interoperability, and trustworthy governance.

### CROSS-REFERENCE TO RELATED APPLICATIONS

This application claims the benefit of U.S. Provisional Patent Application No. 63/847,324, filed on Jul. 20, 2025, the entire contents of which are incorporated herein by reference.

### CPC CLASSIFICATIONS

G06Q 50/01 (Organizational management; social networking)
G06F 16/9535 (Structured data optimization)
H04L 9/32 (Cryptographic mechanisms)
G06N 20/00 (Machine learning applications)
G06Q 50/26 (Public administration; governance systems)

### DEFINITIONS

For clarity and accurate interpretation, the following terms are defined as used in this specification (sorted alphabetically):
Audit Trail Generator: A system component that creates immutable records of moderation actions, outcomes, and compliance details for traceability and regulatory audits.
Ethics Model: A decision framework that applies ethical principles, such as fairness, transparency, and accountability, to content moderation processes.
GDPR: General Data Protection Regulation, an EU framework governing secure processing, storage, and transfer of personal data in content systems.
Mission Alignment: The process of ensuring moderation actions reflect predefined organizational goals, values, and operational priorities.
Moderation Engine: An automated system that manages digital content and interactions using mission-aligned rules, ethical models, and cryptographic validation.

### FIELD OF THE INVENTION

This invention relates to automated content moderation systems that integrate mission alignment, ethical decision-making, and compliance auditing for applications in social networking, online platforms, and distributed governance systems.

### BACKGROUND OF THE INVENTION

Traditional content moderation systems often apply static rules without considering organizational missions or ethical contexts, leading to inconsistent outcomes, potential biases, and regulatory non-compliance.

As digital platforms evolve, a mission-aware engine is needed to embed ethical frameworks, ensure alignment with organizational values, and provide transparent auditing.

Prior art advances automated moderation and governance but lacks integrated mission alignment with ethical models and robust compliance.

The following table summarizes key prior art and their limitations, verified through patent database searches (USPTO, Google Patents, August 2025).

These prior arts advance moderation and trust but fail to integrate mission-driven alignment, ethical frameworks, auditing, and secure outputs, which this invention addresses through a comprehensive engine with contextual processing and compliance features.

### SUMMARY OF THE INVENTION

The Mission-Aware Moderation Engine provides a system and method for ethical content governance by ingesting multi-source content, aligning moderation with missions, applying ethics models, auditing for compliance, and delivering governance outputs.

The system includes a content ingestion module with validation and privacy filters, a mission alignment processor for scoring, an ethics model for decision-making, an audit trail generator for immutable records, and a governance interface for secure delivery.

The method ingests content, aligns actions, applies ethics, audits results, and outputs policies for applications like social platforms and decentralized governance.

Advantages include reduced biases through ethical integration, mission-aligned consistency, GDPR compliance, transparent auditing, and scalable interoperability in digital ecosystems.

### BRIEF DESCRIPTION OF THE DRAWINGS

The drawings illustrate embodiments of the invention and are not intended to limit the scope thereof.

FIG. 1 illustrates the system architecture overview of the content ingestion module, including data inputs, aggregation unit, privacy filter, source verifier, and content classifier.

FIG. 2 illustrates the mission alignment processing pipeline, including layer integration, mission alignment processor, hierarchical integration, weight assignment, and contextual scoring.

FIG. 3 illustrates the ethics model, including decision evaluation, principle checks, fairness validation, bias detection, and cryptographic ethics enforcement.

FIG. 4 illustrates the audit logging workflow, including immutable storage, audit trail generator, outcome recording, compliance checker, and timestamp module.

FIG. 5 illustrates the flowchart of governance output processes, including result formatting, governance interface, policy delivery, encryption unit, and integration API.

### LIST OF FIGURES WITH REFERENCE NUMBERS

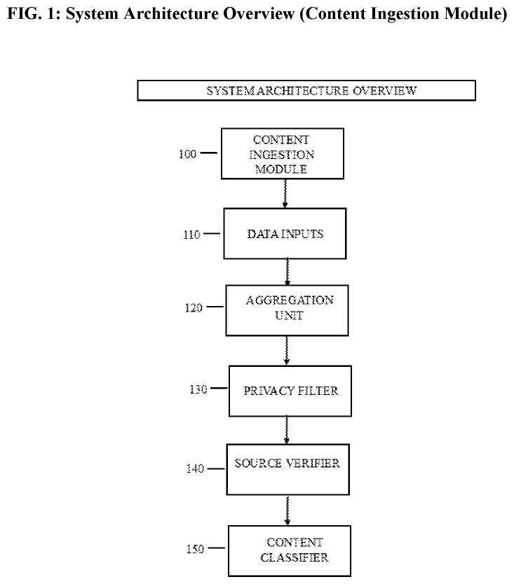

### FIG. 1: System Architecture Overview (Content Ingestion Module)

100: Content Ingestion Module
110: Data Inputs
120: Aggregation Unit
130: Privacy Filter
140: Source Verifier
150: Content Classifier

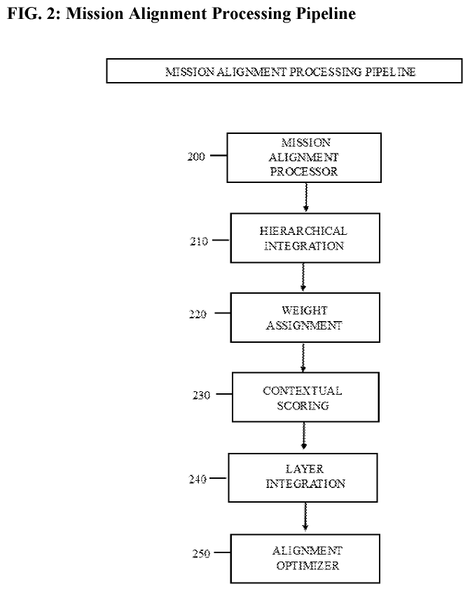

### FIG. 2: Mission Alignment Processing Pipeline

200: Mission Alignment Processor
210: Layer Integration
220: Mission Alignment Processor
230: Hierarchical Integration
240: Weight Assignment
250: Contextual Scoring

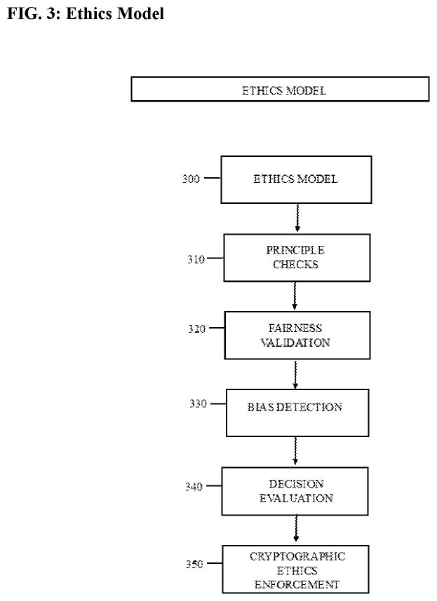

### FIG. 3: ETHICS MODEL

300: Ethics Model
310: Decision Evaluation
320: Principle Checks
330: Fairness Validation
340: Bias Detection
350: Cryptographic Ethics Enforcement

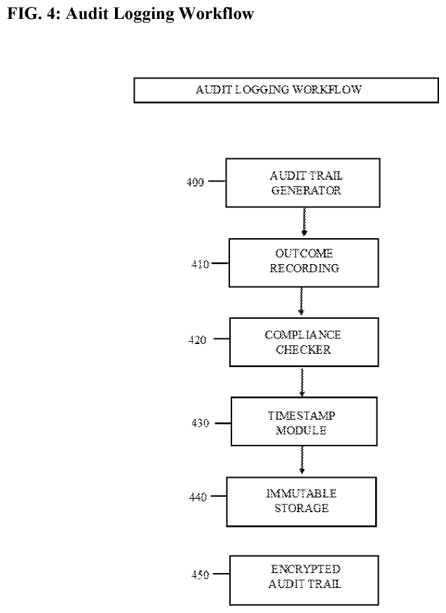

### FIG. 4: Audit Logging Workflow

400: Audit Trail Generator
410: Immutable Storage
420: Audit Trail Generator
430: Outcome Recording
440: Compliance Checker
450: Timestamp Module

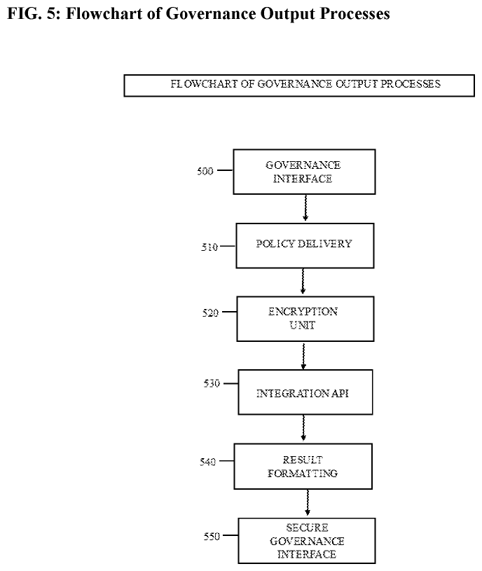

### FIG. 5: Flowchart of Governance Output Processes

500: Governance Interface
510: Result Formatting
520: Governance Interface
530: Policy Delivery
540: Encryption Unit
550: Integration API

### DETAILED DESCRIPTION OF THE INVENTION

The Mission-Aware Moderation Engine (MAME) is a system and method that enables ethical, mission-aligned governance of digital content in distributed platforms.

Content Ingestion Module—As shown in FIG. 1 with reference 100, the content ingestion module ingests multi-source data inputs (reference 110) through the aggregation unit (reference 120), which consolidates content from social media, forums, and blockchain sources.

The privacy filter (reference 130) ensures GDPR-compliant handling by anonymizing personal data.

The source verifier (reference 140) authenticates inputs using cryptographic methods to prevent tampering.

The content classifier (reference 150) categorizes data for mission-aligned processing, enabling efficient moderation.

Mission Alignment Processor—As shown in FIG. 2 with reference 200, the mission alignment processor performs layer integration (reference 210) to merge content data.

Mission alignment processing (reference 220) aligns moderation decisions with organizational goals.

Hierarchical integration (reference 230) organizes content based on priorities.

Weight assignment (reference 240) applies dynamic algorithms to prioritize missions.

Contextual scoring (reference 250) assesses alignment, ensuring mission-driven moderation.

Ethics Model—As shown in FIG. 3 with reference 300, the ethics model conducts decision evaluation (reference 310).

Principle checks (reference 320) ensure ethical compliance.

Fairness validation (reference 330) applies equity assessments.

Bias detection (reference 340) uses machine learning algorithms.

Cryptographic ethics enforcement (reference 350) secures outcomes without data exposure.

Audit Trail Generator—As shown in FIG. 4 with reference 400, the audit trail generator enables immutable storage (reference 410) of moderation actions.

The audit trail generator (reference 420) logs moderation actions.

Outcome recording (reference 430) captures results.

The compliance checker (reference 440) verifies adherence to regulations.

The timestamp module (reference 450) logs events chronologically.

Governance Interface—As shown in FIG. 5 with reference 500, the governance interface facilitates result formatting (reference 510) of moderated results.

Governance interfacing (reference 520) enables secure delivery.

Policy delivery (reference 530) distributes moderated outcomes.

Encryption unit (reference 540) protects outputs in transit.

Integration API (reference 550) enables platform compatibility.

### OPERATIONAL METHOD

The MAME operates by ingesting content through the content ingestion module.

The system aligns moderation actions with missions through the mission alignment processor.

Ethics models are applied to ensure fairness and principled moderation.

Results are audited through immutable logging.

Governance outputs are securely delivered to platforms and systems.

### ADVANTAGES

The MAME provides ethical, aligned moderation.

The system reduces bias through integrated ethics models.

It ensures GDPR compliance.

It enhances transparency through auditability.

It supports scalable governance systems.

What is claimed is:

1. A computerized system for mission-aware content moderation, as shown in FIG. 1 with reference 100, comprising: one or more processors; and memory storing instructions that, when executed, cause the system to: ingest content via a content ingestion module as shown in FIG. 1 with reference 100, including aggregation (reference 120), privacy filtering (reference 130), source verification (reference 140), and content classification (reference 150); align moderation actions with missions via a mission alignment processor as shown in FIG. 2 with reference 200, including layer integration (reference 210), mission alignment processing (reference 220), hierarchical integration (reference 230), weight assignment (reference 240), and contextual scoring (reference 250); apply ethics models via an ethics model as shown in FIG. 3 with reference 300, including decision evaluation (reference 310), principle checks (reference 320), fairness validation (reference 330), bias detection (reference 340), and cryptographic enforcement (reference 350); audit results via an audit trail generator as shown in FIG. 4 with reference 400, including immutable storage (reference 410), audit trail generation (reference 420), outcome recording (reference 430), compliance checking (reference 440), and timestamping (reference 450); output governance via a governance interface as shown in FIG. 5 with reference 500, including result formatting (reference 510), governance interfacing (reference 520), policy delivery (reference 530), encryption (reference 540), and API integration (reference 550).

2. A computer-implemented method for mission-aware content moderation, as shown in FIG. 1 with reference 100, comprising: ingesting content via a content ingestion module as shown in FIG. 1 with reference 100, including aggregation (reference 120), privacy filtering (reference 130), source verification (reference 140), and content classification (reference 150); aligning actions with missions as shown in FIG. 2 with reference 200, including layer integration (reference 210), mission alignment processing (reference 220), hierarchical integration (reference 230), weight assignment (reference 240), and contextual scoring (reference 250); applying ethics models as shown in FIG. 3 with reference 300, including decision evaluation (reference 310), principle checks (reference 320), fairness validation (reference 330), bias detection (reference 340), and cryptographic enforcement (reference 350); auditing results as shown in FIG. 4 with reference 400, including immutable storage (reference 410), audit trail generation (reference 420), outcome recording (reference 430), compliance checking (reference 440), and timestamping (reference 450); outputting governance as shown in FIG. 5 with reference 500, including result formatting (reference 510), governance interfacing (reference 520), policy delivery (reference 530), encryption (reference 540), and API integration (reference 550).

3. A non-transitory computer-readable storage medium storing instructions that, when executed by a processor, cause performance of a method for mission-aware content moderation, as shown in FIG. 1 with reference 100, comprising: ingesting content via a content ingestion module as shown in FIG. 1 with reference 100, including aggregation (reference 120), privacy filtering (reference 130), source verification (reference 140), and content classification (reference 150); aligning actions with missions as shown in FIG. 2 with reference 200, including layer integration (reference 210), mission alignment processing (reference 220), hierarchical integration (reference 230), weight assignment (reference 240), and contextual scoring (reference 250); applying ethics models as shown in FIG. 3 with reference 300, including decision evaluation (reference 310), principle checks (reference 320), fairness validation (reference 330), bias detection (reference 340), and cryptographic enforcement (reference 350); auditing results as shown in FIG. 4 with reference 400, including immutable storage (reference 410), audit trail generation (reference 420), outcome recording (reference 430), compliance checking (reference 440), and timestamping (reference 450); outputting governance as shown in FIG. 5 with reference 500, including result formatting (reference 510), governance interfacing (reference 520), policy delivery (reference 530), encryption (reference 540), and API integration (reference 550).

4. The system of claim 1, wherein content includes multi-platform data from social media, forums, and blockchain-based sources, ingested via the content ingestion module as shown in FIG. 1 with reference 110.

5. The system of claim 1, wherein mission alignment integrates organizational goals via hierarchical integration as shown in FIG. 2 with reference 230.

6. The system of claim 1, wherein ethics application uses bias detection and cryptographic enforcement for fairness as shown in FIG. 3 with reference 340 and reference 350.

7. The system of claim 1, wherein audits generate immutable logs via immutable storage as shown in FIG. 4 with reference 410.

8. The system of claim 1, wherein outputs support governance and platform moderation applications via API integration as shown in FIG. 5 with reference 550.

9. The system of claim 1, wherein instructions dynamically adapt alignment weights based on mission priorities and content context as shown in FIG. 2 with reference 240.

10. The method of claim 2, wherein ingesting includes GDPR-compliant data handling with privacy filters as shown in FIG. 1 with reference 130.

11. The method of claim 2, wherein aligning applies contextual algorithms for layer integration as shown in FIG. 2 with reference 210.

12. The method of claim 2, wherein applying ethics ensures fairness and principle compliance via fairness validation and cryptographic enforcement as shown in FIG. 3 with reference 330 and reference 350.

13. The method of claim 2, wherein auditing incorporates timestamped records via immutable storage as shown in FIG. 4 with reference 410.

14. The method of claim 2, wherein outputting delivers governance policies via API integration as shown in FIG. 5 with reference 550.

15. The system of claim 1, further comprising integration of machine learning models in the ethics model for enhanced bias detection as shown in FIG. 3 with reference 340, wherein the models adapt based on historical moderation data without compromising privacy.

16. The method of claim 2, further comprising generating verifiable governance profiles from aligned content, applicable across platforms using the governance interface as shown in FIG. 5 with reference 520.
